(19) United States
(12) Patent Application Publication
(10) Pub. No.: US 2013/0125398 A1
(43) Pub. Date: May 23, 2013

(54) METHOD FOR PRODUCING A CUSTOMIZED ORTHODONTIC APPLIANCE, AND APPLIANCE THUS PRODUCED

(71) Applicants: Patrick Curiel, Neuilly (FR); William Ayache, Nueilly Sur Seine (FR); Philippe Salah, Paris (FR)

(72) Inventors: Patrick Curiel, Neuilly (FR); William Ayache, Nueilly Sur Seine (FR); Philippe Salah, Paris (FR)

(73) Assignee: H 32, Paris (FR)

(21) Appl. No.: 13/512,181

(22) PCT Filed: Nov. 24, 2010
(86) PCT No.: PCT/FR2010/052506

§ 371 Date: Jan. 22, 2013

(30) Foreign Application Priority Data
Nov. 25, 2009 (FR) FR0958348

(51) Int. Cl. A61C 7/00

(52) U.S. Cl. CPC A61C 7/00
USPC 29/896.1

(57) ABSTRACT

A method of producing a customized orthodontic appliance for treating a patient where the appliance includes at least one orthodontic arch and a plurality of elements each including a bracket provided with at least one slot in which said orthodontic arch can be inserted. Each bracket being configured to be placed on a base intended to be placed on a posterior face of a tooth. The method includes individual numerical design of said bases after forming a model representing the dental arch and the faces of the teeth to which said bases are to be fixed in the corrected position. At least some of said bases are numerically designed and manufactured using rapid prototyping. A mass-produced bracket is fixed to each of said bases. An orthodontic arch is numerically designed and manufactured so that it follows the curvature of the dental arch in the corrected position.

The invention relates to a method for producing a customized orthodontic appliance for treating a patient, which is intended to be used in the case of a lingual technique, that is to say a technique in which the appliance is positioned on the non-visible posterior face of the teeth.

Conventionally, such appliances comprise:
at least one orthodontic arch, in other words a metal wire which applies to the teeth a force which tends to bring them, from their unsatisfactory or “maloccluded” initial position to a satisfactory final position known as the “corrected position”;
and a series of brackets (the English term “brackets” is commonly found in other languages) each provided with at least one slot to accept an orthodontic arch; these brackets are individually fixed to the patient's teeth, in a determined position that allows the orthodontic arch to transfer to the teeth the forces necessary for them to move from the maloccluded position into the corrected position during the course of treatment.

More commonly, one or more orthodontic arches, and with it or them a single series of brackets each comprising one or more slots, are used.

At the present time, there are two competing processes for the industrial manufacture of orthodontic brackets: mass production and rapid prototyping. It is important first of all to define these types of manufacture.

Mass production calls for tooling specially designed for each type, form or model of component to be produced. These mass-produced components have a very high dimensional accuracy of the order of 1/100 mm. Manufacture of the first mass-produced component takes time in designing and programming the tooling, but once these two operations have been performed, the next components can be mass produced in vast numbers in a very short space of time, thus compensating for the significant cost of the special tooling. Conventionally, the methodologies used for producing mass-produced orthodontic brackets are metal injection molding (MIM), ceramic injection molding (CIM), extrusion cutting and machining (the various machining methods are described in standard NFE 05-019).

“Rapid prototyping” or “additive or subtractive fabrication” involves producing the component by progressively adding or subtracting layers of material for direct or indirect fabrication. Fabrication is direct if it is performed notably by laser sintering, indirect if it is performed notably by the lost wax casting method. Using this method, a single customized bracket can be produced more quickly than by machining or by some other method that calls for specialist tooling. However, the dimensional precision of this method is only of the order of 1/10 mm, which may be insufficient. Because of that, rapid prototyping is ill-suited to the creation of complex shapes and, more particularly, of precise orthodontic brackets.

Historically, lingual orthodontic techniques, which have the esthetic advantage of leaving the appliance practically invisible from the outside, began to develop in around 1980 and used mass-produced brackets. However, at that time they were reliant on an entirely manual fitting of the appliances and they were very complicated to perform. Specifically, an important factor in the success of the treatment is the correct positioning of the bracket and therefore of its slot on the tooth, because it is this positioning that determines the orientation of the forces that are applied to the corresponding tooth, and therefore the orientations of the tooth in the various directions in space when it is in its corrected final position. This positioning is far trickier to perform in a lingual technique than in a technique known as a labial or vestibular technique (where the appliance is positioned on the anterior face of the teeth), because of the morphological heterogeneity of the posterior faces of the teeth. This particularity means that a slight error in the positioning of the bracket may situate the slot in an incorrect position incapable of affording the desired correction to the position of the tooth.

An improvement to this technique was the system known as the CLASS system which involves taking two plaster castings of an impression of the dental arch and of the maloccluded teeth of the patient. One of these castings is kept and the other is used by the technician to produce a model of the dental arch with the teeth in the corrected final position. To do that, the teeth from the casting are sawn out one by one and repositioned in said corrected positions (this step is commonly known as the “set-up”). The technician then positions mass-produced brackets on existing gauges which he considers best suited to the internal curvature of the teeth in determined regions of the dental arch (for example facing the incisors, facing each of the canines, facing each of the series of premolars and facing each of the series of molars), and brings these gauge-bracket assemblies closer to the teeth of the casting. Each gauge template corresponds to a preformed arch available from a range of standard orthodontic arches. The result is that one or some of the mass-produced brackets may press directly against the teeth of the cast, but that there are empty spaces between the other brackets and the other teeth. These empty spaces are filled with a resinous material to hold the brackets in place. A photocopy is then taken of the casting with the brackets in place, and from this photocopy the shape of the orthodontic arch that will be needed in order to bring the teeth into the corrected position is determined. The brackets are then partially imprisoned in little resin shells, they are placed on the teeth of the casting of the teeth in the maloccluded position using retaining devices, and a silicone transfer tray for the entire dental arch is then produced, using which tray all the brackets can be transferred simultaneously in a single operation by bonding onto the maloccluded teeth of the patient. The preformed orthodontic arch is then positioned in the slots of the mass-produced brackets, in which it is then immobilized by closing the entrance to the slot to prevent it from escaping therefrom, and treatment can commence.

This technique does, however, have a number of disadvantages. The mass of resin via which the empty space between the bracket and its corresponding tooth is filled and bracket-tooth attachment is afforded during treatment can be gauged only relatively approximately. Its material is liable to age and no longer be able to correctly perform its role in the repositioning of the teeth. Further, should this material fail, it is not possible to restore it to its, theoretically ideal, initial shape. The use of existing gauges and retaining devices which are therefore of standardized dimensions means that the positioning of the brackets that they can achieve are not always ideally suited to the precise morphology of the patient's dental arch. In general, this method requires a great deal of production time and extremely well qualified and accurate technicians so that it can be put into practice under the best possible conditions in order to obtain the best desirable results. Its use is restrictive to the patient because the orthodontic arches are not precisely suited to the morphology of the patient. However, this methodology does have the advantage of allowing the use of mass-produced brackets which can already incorporate what is known as a “self-ligating bracket” system in which the arch is immobilized in the slot by clipping or the like.

Computer-aided design and manufacturing techniques using “rapid prototyping” have been able to provide significant optimizations to the ease with which customized orthodontic appliances specific to each patient can be designed.

In particular, document WO-A-03/068099 teaches the individualized design of a set formed, on the one hand, of a virtual image of a base for fixing to the tooth, numerically designed on the basis of a computerized image of the patient's dental arch with the teeth in the corrected position and, on the other hand, a virtual image of a bracket provided with a slot for the insertion of the orthodontic arch, this image being taken from a virtual library of brackets of predetermined shapes. A bracket formed of a single body resulting from the combination of these two images is then produced. An orthodontic arch is then designed, shaped using a special device, intended to connect the brackets and to bring the patient's teeth into the corrected position. This arch inevitably has a complex shape, particularly since it is made up of a succession of multiple regions with different radii of curvature, something which is necessary in order to connect the brackets, and may extend in all three dimensions of space.

The disadvantages of this technique are chiefly as follows. Because the body which forms both the base fixed to the tooth and the bracket bearing the slot for the insertion of the arch is designed and manufactured as a single unit by rapid prototyping, it is difficult to produce bracket systems which are optimized in terms of the shape of the brackets. In particular, this technique is unable at the present time to use “self-ligating” brackets. This type of bracket, the use of which is becoming increasingly widespread, appears to be a significant factor in the full success of the treatment. In addition, the shaping of the orthodontic arch, because of its complexity, has to be done by robot, using materials that have precise characteristics so that they are able to adopt and retain this shape. Further, should a change to the shape of the arch appear necessary at the start or during the course of the treatment, this cannot be done without changing the entire arch, this leading to a prejudicial loss of time to the patient and the practitioner. The modularity of the appliance is therefore limited. Finally, the high number of bends in the arch which, as has already been stated, may generally extend substantially into all three dimensions of space, considerably limits its ability to slide along inside the slots of the brackets, even though this ability to slide would be favorable to the good progress of the treatment in order to follow the movement of the teeth into their corrected position.

Application WO-A-2009/056776 in the name of the Applicant also proposes the joint use:
of the formation, using a numerical method, individually for each tooth, of a set formed of a base that follows the shape of that face of the tooth to which it will be fixed, of a bracket provided with a slot in which an orthodontic arch will be inserted, and of a prototyped intermediate part between the base and the bracket the geometry of which corresponds to the space which, without it, would be left empty at the end of the treatment between the corresponding tooth in its corrected position and the orthodontic arch that will have reverted to its initial shape; this set may be produced in the form of a single component incorporating all the parts that have just been mentioned, or in the form of two or three separate components which are then joined together;
and of an orthodontic arch the shape and dimensions of which can be standardized, having a curvature that is substantially continuous with the possible exception of regions corresponding, for example, to the transition between teeth or groups of teeth of different kinds (for example between canines and premolars and/or between premolars and molars) and which defines a succession of portions, each having a substantially continuous curvature.

In any event, this arch has not undergone any complex shaping operation aimed at fine-tuning its shape to suit each of the patient's teeth.

The orthodontic arch may thus be of the known “straight wire” type running in a single plane and manufactured according to standardized models.

This method does, however, have the feature, which may be a disadvantage, of requiring the production of brackets which, at least for the most part, are of non-standard shapes and sizes. These brackets may be produced by “rapid prototyping”. However, the surface finish of the bracket is then not optimal and may vary from one item to another, even though the quality of this surface finish is a significant factor in the proper working of the appliance: the orthodontic arch needs to be able to slide effortlessly along inside the bracket. In addition, each component is, by definition, unique, and producing a set of brackets which are all or practically all different for a complete appliance takes a great deal of time, even when brackets some of which are identical could be produced.

It is an object of the invention to propose a method for designing and manufacturing an orthodontic appliance which is able to achieve an excellent compromise between the contradictory requirements of the precision with which the appliance is produced and the minimal cost of this production, while at the same time of course maintaining optimum performance in terms of the success of the orthodontic treatment.

To this end, one subject of the invention is a method of producing a customized orthodontic appliance for treating a patient, said appliance comprising at least one orthodontic arch for treatment purposes and a plurality of elements each comprising a bracket provided with at least one slot in which said orthodontic arch can be inserted, each bracket being intended to be placed on a base intended to be placed on a posterior face of a tooth, said method anticipating numerical design of said bases individually after having formed a model representing, in the corrected position, the dental arch and the faces of the teeth to which said bases are to be fixed, characterized in that:
at least some of said bases are numerically designed and manufactured using rapid prototyping;
a mass-produced bracket is fixed to each of said bases;
and a bent orthodontic arch is numerically designed and manufactured shaping it specially so that after it has been inserted in the slots of said brackets it follows the curvature of the dental arch in the corrected position.

Thus, each base and its adapter compensate for the differences in morphology of posterior faces of the teeth.

In order to produce said bent arch, it is possible for the profile of the orthodontic arch to be numerically designed in parallel with the profile of the base and orthodontic bracket pairing.

In an alternative form of the invention, in order to produce said bent arch:
a digital image of said model equipped with said prototyped bases is produced;
precise points of said brackets are identified in space on said digital image;
the results of these identifications are entered into the software of an apparatus for manufacturing a specially bent orthodontic arch;
said bent orthodontic arch is produced using said apparatus;
and said arch is fitted into said slots in said brackets.

All of said bases may be manufactured by rapid prototyping.

Another subject of the invention is a customized orthodontic appliance for treating a patient, said appliance comprising at least one orthodontic arch for treatment purposes and a plurality of elements each comprising a bracket provided with at least one slot in which said orthodontic arch can be inserted, each bracket being intended to be placed on a base intended to be placed on a posterior face of a tooth, characterized in that at least some of the bases are manufactured by rapid prototyping, the brackets are mass-produced brackets, the orthodontic arch is a specially bent arch, and said appliance is produced using the above method.

For preference, at least some of the brackets are self-ligating.

As will have been understood, the method according to the invention makes it possible to reach a compromise between various techniques which are known in isolation, combining their advantages, that is to say the technologies of production by computer-aided prototyping and mass production, but which are grouped together here to form a coherent whole that allows a top-end appliance to be obtained at the lowest possible cost.

Unlike the method described in application WO-A-2009/056776, this method entails the manufacture of a specially bent orthodontic arch rather than being able simply to use a standard (straight wire) orthodontic arch or one that just has a limited number of bends at standardized locations and shapes. The advantage of the method according to the invention is that it makes it possible to make exclusive use of “mass-produced” brackets, which have therefore been prepared in advance and have well standardized shapes and sizes, coupling the use of these with prototyped bases, therefore bases tailored to the morphology of the posterior face of the teeth. This prototyped base and standardized bracket pairing has the obvious advantage of combining the precision with which the bases can be positioned with the very high dimensional precision of the mass-produced brackets, and the possibility of these being self-ligating.

In particular, the slot into which the arch is inserted is configured with excellent dimensional precision; that allows the arch to be positioned therein with minimal clearance, and therefore allows it to perform its action on the tooth with a precision which is as high as desirable in order to bring it into its intended final position. Likewise, the slot can be given a complex shape providing one or more anti-friction regions where there is no contact between the bracket and the arch.

Mass-producing the bracket also allows the latter to be given a complex shape, this easily being able to incorporate a self-ligating device, something that manufacture by rapid prototyping will not permit or will permit under far less satisfactory operating conditions. If no self-ligating system is available on the bracket, then the arch has to be held in the slot by means of an elastomer plug added to the bracket. This approach increases the time spent fitting or adjusting the appliance in each visit, whereas in the case of a self-ligating bracket, a simple action by the orthodontist on the element that provides the ligature is enough to achieve this holding. In addition, the element that performs this self-ligating function has the same surface qualities as the remainder of the bracket, whereas the elastomer plug has a high coefficient of friction with the metal of the arch which impedes the sliding of the arch in the slot and therefore the correct bringing of the tooth into position from its maloccluded position. Finally, it is also recognized that elastomeric ligatures suffer substantial degradation in their mechanical properties after just a few weeks, or even a few days. Thus, the use of self-ligating brackets means that the mechanics of sliding of the tooth-base-bracket sets along the orthodontic arch becomes better and the long-term retention of the arch in its slot becomes more reliable.

For preference, all of the brackets are self-ligating, but of course provision can be made for just some of them to be of this type.

The numerical design of the bases is performed on the basis of a numerical model of the dental arch in the corrected position and of the geometric parameters of the brackets intended for them. In parallel with this, the method provides for numerical design of the orthodontic arches. The numerical CAD-generated files will be used for producing the bases using rapid prototyping, this method having sufficient precision for their manufacture. Certain bases may be produced by rapid prototyping and others by some other method without departing from the spirit of the invention. The numerical arch design files will, for their part, be used for producing the arches using machines for the automatic shaping of orthodontic wire.

The bases are then installed on the model of the dental arch and the mass-produced brackets, which have already been manufactured and can therefore be taken from an existing stock of models which are standardized in terms of shape and dimensions, are fixed to the bases by welding or by any other means of reliable attachment (bonding or clipping if the designs of the base and of the bracket so permit).

In an alternative form of the method, the orthodontic arches are not designed until a second step, rather than being designed in parallel. Thus:
a new digital image of said model equipped with said brackets is produced;
precise characteristic points of said brackets, particularly of the positioning of their slots in space are identified in space on said digital image;
the results of these identifications are entered into the software of an apparatus for producing a bent orthodontic arch;
said bent orthodontic arch is produced using said apparatus;
and said arch is fitted into said slots in said brackets.

The appliance is thus produced and can be transferred to the patient's dental arch using conventional techniques.

1. Method of producing a customized orthodontic appliance for treating a patient, said appliance comprising at least one orthodontic arch for treatment purposes and a plurality of elements each comprising a bracket provided with at least one slot in which said orthodontic arch can be inserted, each bracket being intended to be placed on a base intended to be placed on a posterior face of a tooth, said method anticipating numerical design of said bases individually after having formed a model representing, in the corrected position, the dental arch and the faces of the teeth to which said bases are to be fixed, characterized in that:
at least some of said bases are numerically designed and manufactured using rapid prototyping;
a mass-produced bracket is fixed to each of said bases;
and a bent orthodontic arch is numerically designed and manufactured shaping it specially so that after it has been inserted in the slots of said brackets it follows the curvature of the dental arch in the corrected position.

2. Method according to claim 1, characterized in that, in order to produce said bent arch, the profile of the orthodontic arch is numerically designed in parallel with the profile of the base and orthodontic bracket pairing.

3. Method according to claim 1, characterized in that, in order to produce said bent arch:
a digital image of said model equipped with said prototyped bases is produced;
precise points of said brackets are identified in space on said digital image;
the results of these identifications are entered into the software of an apparatus for manufacturing a specially bent orthodontic arch;
said bent orthodontic arch is produced using said apparatus;
and in that said arch is fitted into said slots in said brackets.

4. Method according to claim 1, characterized in that all of said bases are manufactured by rapid prototyping.

5. Customized orthodontic appliance for treating a patient, said appliance comprising at least one orthodontic arch for treatment purposes and a plurality of elements each comprising a bracket provided with at least one slot in which said orthodontic arch can be inserted, each bracket being intended to be placed on a base intended to be placed on a posterior face of a tooth, characterized in that at least some of the bases are manufactured by rapid prototyping, the brackets are mass-produced brackets, in the orthodontic arch is a specially bent arch, and in that said appliance is produced using the method according to claim 1.

6. Customized orthodontic appliance for treating a patient according to claim 5, characterized in that at least some of the brackets are self-ligating.
